(19) United States
(12) Patent Application Publication
(10) Pub. No.: US 2014/0178797 A1
(43) Pub. Date: Jun. 26, 2014

(54) SOLID OXIDE FUEL CELL

(71) Applicant: SAMSUNG ELECTRO-MECHANICS CO., LTD., Suwon (KR)

(72) Inventors: Jong Sik Yoon, Suwon (KR); Sung Han Kim, Suwon (KR); Jong Ho Chung, Suwon (KR); Bon Seok Koo, Suwon (KR)

(73) Assignee: SAMSUNG ELECTRO-MECHANICS CO., LTD., Suwon (KR)

(21) Appl. No.: 13/773,392

(22) Filed: Feb. 21, 2013

(30) Foreign Application Priority Data
Dec. 26, 2012 (KR) 10-2012-0152985

(51) Int. Cl. H01M 8/02

(52) U.S. Cl. CPC H01M 8/0247
USPC 429/508

(57) ABSTRACT

Disclosed herein is a solid oxide fuel cell including: a unit cell including an anode, an electrolyte, and a cathode; an interconnector including a planar body, a plurality of through holes penetrating through the body, a bar inserted into the through hole and made of an electrical conductor, and a lower enclosure protruding from one surface of the body so as to enclose the through hole; and a sealant arranged along edges of the unit cell and the interconnector.

### CROSS REFERENCE TO RELATED APPLICATION

This application claims the benefit of Korean Patent Application No. 10-2012-0152985, filed on Dec. 26, 2012, entitled “Solid Oxide Fuel Cell”, which is hereby incorporated by reference in its entirety into this application.

### BACKGROUND OF THE INVENTION

1. Technical Field

The present invention relates to a solid oxide fuel cell, and more particularly, to a planar solid oxide fuel cell.

2. Description of the Related Art

Since reserves of petroleum widely used as an energy source is limited, an alternative energy source capable of substituting petroleum has been nationally and socially spotlighted. For example, the interest in power generation using solar energy, tidal energy, and wind energy that are not fossil fuels, fuel cell, or the like, has increased.

The fuel cell, which is a device generating electricity using an inverse reaction of water electrolysis, converts hydrogen contained in hydrocarbon based materials such as natural gas, coal gas, methanol, or the like, and oxygen in the air into electric energy through electrochemical reactions.

The existing power generation technologies should perform processes such as fuel combustion, steam generation, turbine driving, power generator driving, or the like, while the fuel cell does not require fuel combustion or a driving apparatus, such that the fuel cell may have high power generation efficiency. In addition, the fuel cell minimally discharges air pollutants such as SOₓ, NOₓ, or the like, and generates less carbon dioxide, and noise or vibration is hardly generated.

There are various kinds of fuel cells, for example, a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC), or the like.

Among them, the solid oxide fuel cell (SOFC) depends on activation polarization, which lowers over-voltage and irreversible loss to increase power generation efficiency. In addition, various fuel may be used without reforming thereof, for example, carbon or hydrocarbon based fuel as well as hydrogen may be used, such that fuel may be variously selected, and since the reaction rate in electrodes is rapid, the SOFC does not need to use expensive precious metals as an electrode catalyst. Further, since heat having a significantly high temperature is generated during the reaction, this heat may be used to reform fuel and used as an industrial or cooling energy source.

In the solid oxide fuel cell (SOFC) as described above, electrodes reactions as the following reaction formulas are carried out.

<Reaction Formula>

Anode Reaction: H₂+O²⁻→H₂O+2e−CO+O²→CO₂+2e−

Cathode Reaction: O₂+4e−→2O²⁻

Overall Reaction: H₂+CO+O₂→H₂O+CO₂

In the fuel cell operated according to the above-mentioned reaction formula, electrons are transferred to the cathode through an external circuit, and at the same time, oxygen ions generated in the cathode are transferred to the anode through an electrolyte, such that hydrogen or carbon monoxide (CO) is bonded to oxygen ions to generate electrons and water or carbon dioxide (CO₂) in the anode.

In a planar solid oxide fuel cell according to the prior art, an interconnector assisting in stacking unit cells while providing a flow channel of fuel or gas such as air, or the like, is used. This interconnector may collect electricity generated in the unit cells arranged at upper and lower portions of the fuel cell.

For example, an interconnector made of ferritic stainless steel containing chrome has been disclosed in International Patent Application No. WO 2006/138070 (Patent Document 1). This ferritic stainless steel interconnector may provide electric conductivity while slowly growing oxide scale at a solid oxide fuel cell operating temperature.

As widely known to those skilled in the art, problems that an interconnector made of a metal alloy is oxidized at high temperature under an oxidizing atmosphere to form an oxide scale, a chrome (Cr) component in the metal alloy is migrated to the electrode or electrolyte at a high temperature and react with components of the electrode or the electrolyte which decrease durability of unit cells are not solved.

### PRIOR ART DOCUMENT

### Patent Document

(Patent Document 1) International Patent Publication No. WO 2006/138070

### SUMMARY OF THE INVENTION

The present invention has been made in an effort to provide a solid oxide fuel cell capable of securing oxidation resistance and electric conductivity of an interconnector.

According to a preferred embodiment of the present invention, there is provided a solid oxide fuel cell including: a unit cell including an anode, an electrolyte, and a cathode; an interconnector including a planar body, a plurality of through holes penetrating through the body, a bar inserted into the through hole and made of an electrical conductor, and a lower enclosure protruding from one surface of the body so as to enclose the through hole; and a sealant arranged along edges of the unit cell and the interconnector.

The body and the lower enclosure of the interconnector may be made of an insulating ceramic material.

One end of the bar may be arranged at the same level as that of the lower enclosure, and the other end of the bar may be arranged to protrude upwardly from a flat planar surface of the body, thereby forming channels on the upper and lower surfaces of the body, respectively.

The bar may have a length longer than the sum of a thickness of the body and a length of the lower enclosure.

The lower enclosure may have a frame shape so as to enclose the plurality of bars arranged in a row.

Alternatively, the lower enclosure may have a cylindrical shape so as to enclose an edge of the through hole.

The solid oxide fuel cell may further include an upper enclosure protruding from the other surface of the body so as to enclose the through hole. The upper enclosure may be made of an insulating ceramic material.

The bar may have the same length as the sum of a length of the upper enclosure, a length of the lower enclosure, and a thickness of the body.

The upper enclosure may have a frame shape so as to enclose the plurality of bars arranged in a row, and the upper and lower enclosures may be formed to be perpendicular to each other, thereby forming channels at upper and lower portions of the body, respectively.

The upper enclosure may have a cylindrical shape so as to enclose an edge of the through hole.

Selectively, the solid oxide fuel cell may further include a conductive paste additionally arranged at the uppermost end portion or lowermost end portion of the enclosure.

Selectively, the solid oxide fuel cell may further include a conductor additionally arranged at the uppermost end portion or lowermost end portion of the enclosure.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic cross-sectional view of a solid oxide fuel cell according to a preferred embodiment of the present invention;

FIG. 2 is a cross-sectional view schematically showing an interconnector according to the preferred embodiment of the present invention;

FIG. 3 is a plan view of the interconnector shown in FIG. 2;

FIG. 4 is a bottom view of the interconnector shown in FIG. 2;

FIG. 5 is a cross-sectional view schematically showing an interconnector according to another preferred embodiment of the present invention; and

FIG. 6 is a plan view of the interconnector shown in FIG. 5.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

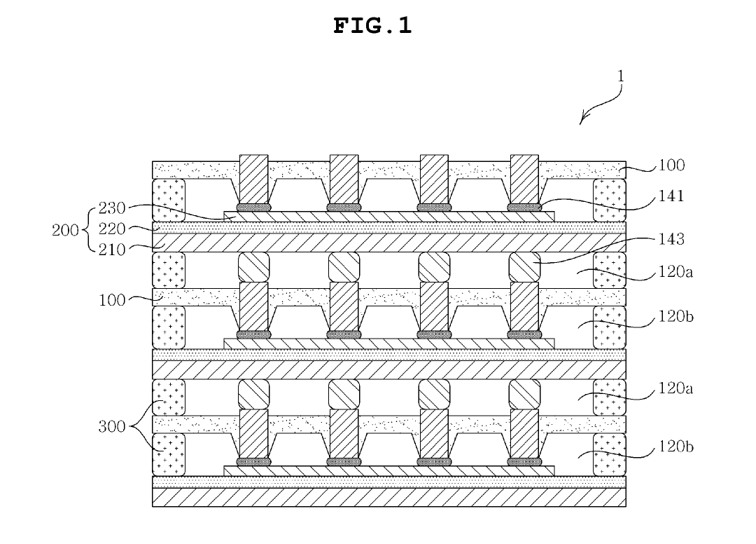

Referring to FIG. 1, the solid oxide fuel cell 1 according to the preferred embodiment of the present invention, which is a planar solid oxide fuel cell, includes a unit cell 200 in which an anode 210, an electrolyte 220, and a cathode 230 that are formed in a planar shape are stacked.

As shown in FIG. 1 the solid oxide fuel cell 1 according to the present invention is configured to include at least one interconnector 100, at least one unit cell 200, and sealants 300. Particularly, the interconnector 100 forms a channel 120a or 120b capable of supplying reaction gas (fuel gas or air) to the unit cell 200.

Here, the term “interconnector” means basically a constituent member capable of electrically connecting an anode of a unit cell to a cathode of another unit cell arranged to be adjacent to each other but physically blocking air supplied to the cathode from fuel gas supplied to the anode.

The unit cell 200, which serves to generate electric energy, is formed by stacking the anode 210, the electrolyte 220, and the cathode 230 therein as described above. The anode 210 receives fuel from the channel 120a of the interconnector 100 to serve as an anode through an electrode reaction. The anode 210 is formed by heating nickel oxide (NiO) and yttria stabilized zirconia (YSZ) to 1200 to 1300° C., wherein nickel oxide is reduced to metallic nickel by hydrogen to exhibit electron conductivity, and yttria stabilized zirconia (YSZ) exhibits ion conductivity as an oxide.

The electrolyte 220, which is a medium transferring the oxygen ions generated in the cathode 230 to the anode 210, may be formed by performing the coating using a dry coating method such as a plasma spray method, an electrochemical deposition method, a sputtering method, an ion beam method, an ion implantation method, or the like, or a wet coating method such as a tape casting method, a spray coating method, a dip coating method, a screen printing method, a doctor blade method, or the like, and then performing the sintering at 1300 to 1500° C. The electrolyte 220 is formed on the outside of the anode using YSZ or scandium stabilized zirconia (ScSZ), gadolinia-doped ceria (GDC), La₂O₃-Doped CeO₂ (LDC), or the like, wherein since in the yttria stabilized zirconia, tetravalent zirconium ions are partially substituted with trivalent yttrium ions, one oxygen hole per two yttrium ions is generated therein, and oxygen ions move through the hole at a high temperature. Meanwhile, since the electrolyte 220 has low ion conductivity, voltage drop is less generated due to ohmic polarization. Therefore, it is preferable that the electrolyte is formed as thin as possible. If pores are generated in the electrolyte 220, since a crossover phenomenon of directly reacting fuel (hydrogen) with air (oxygen) may be generated to reduce efficiency, it needs to be noted so that a scratch is not generated.

The cathode 230 receives oxygen or air from the channel 120b of the interconnector 100 to serve as a cathode generating positive current through an electrode reaction. The cathode 230 may be formed by coating lanthanum strontium manganite ((La_{0.84} Sr_{0.16}) MnO₃) having high electron conductivity, or the like, using a dry coating method or a wet coating method similar to that in the electrolyte, and then sintering the coated lanthanum strontium manganite at 1200 to 1300° C. That is, air (oxygen) is converted into oxygen ion by a catalytic action of lanthanum strontium manganite in the cathode and transferred to the anode 210 through the electrolyte 220.

The solid oxide fuel cell 1 according to the preferred embodiment of the present invention includes at least one unit cell 200 as shown in FIG. 1, and the case in which the solid oxide fuel cell 1 includes three unit cells 200 is shown in FIG. 1. The interconnectors 100 are disposed between three unit cells 200 disposed in parallel with each other. A lower surface of the interconnector 100 contacts the cathode 230 of the unit cell 200 under an oxidizing atmosphere, and an upper surface of the interconnector 100 contacts the anode 210 under a reducing atmosphere as shown FIG. 1. However, the present invention is not limited thereto. For example, according to the state in which the unit cells 200 are stacked, the upper surface of the interconnector is exposed to the reducing atmosphere, and the lower surface thereof is exposed to the oxidizing atmosphere.

The sealant 300 is disposed along edges of the interconnector 100 and the unit cell 200 that will be stacked to insulate these constituent members from each other and prevent leakage of gas. To this end, the sealant 300 may be made of a ceramic material or a glass material.

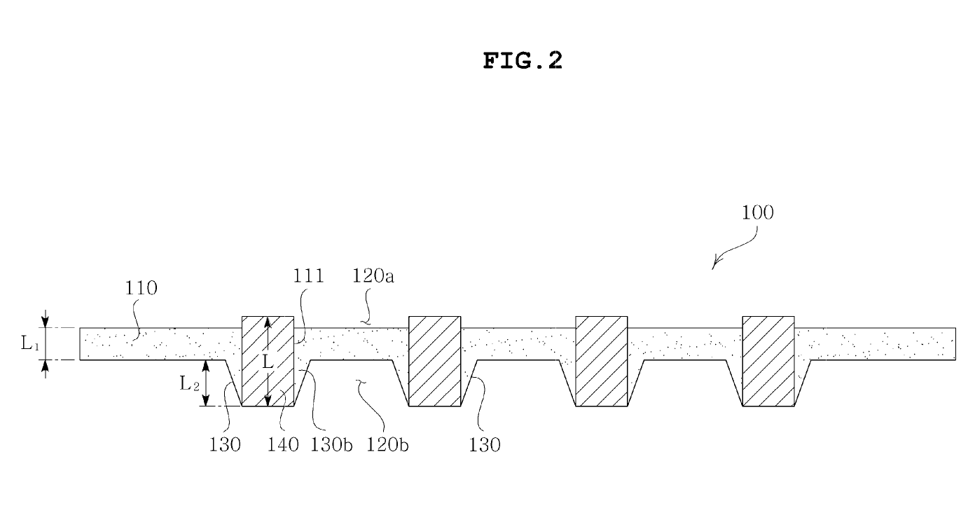

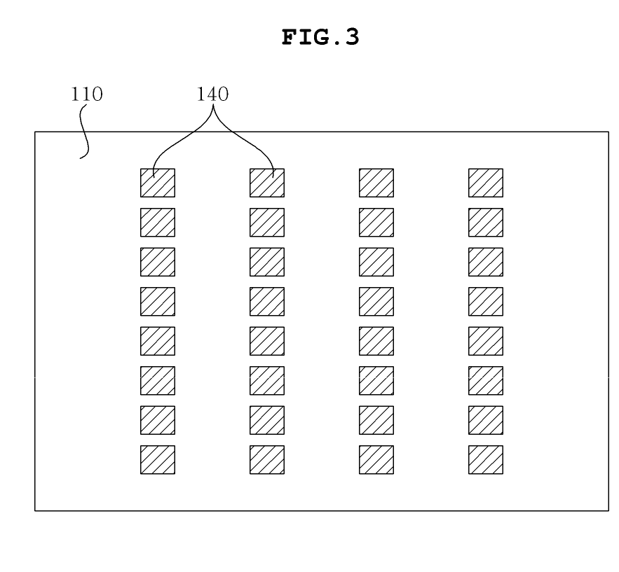

The interconnector 100 according to the preferred embodiment of the present invention that is to be used in the solid oxide fuel cell will be described with reference to FIGS. 2 to 4.

The interconnector 100 according to the present invention may be made of an insulating ceramic material in consideration of characteristics of the solid oxide fuel cell having heat resistance, oxidation resistance, and abrasion resistance and operating even at high temperature.

The interconnector 100 for the solid oxide fuel cell according to the present invention includes a body 110 having a plurality of through holes 111 punched therethrough in a planar shape, and thin and long bars 140, and a lower enclosure 130b on one surface of the body 110, wherein the enclosure is extended to be long downwardly from a lower surface of the body 110 in a vertical direction. However, the present invention is not limited thereto. As needed, the enclosure may be formed on an upper surface of the interconnector 100.

Since the body 110 of the present invention is made of the ceramic material, which is an insulating material having oxidation resistance, as described above, the anode and the cathode are electrically connected with each other through the plurality of bars 140 inserted into the through holes 111 of the body 110. To this end, the bar 140 may be made of a conductive material.

The plurality of bars 140 are inserted into the through holes 111 of the body 110 to allow the upper and lower surfaces of the interconnector 100 to be electrically connected with each other as shown, wherein a length L of the bar 140 needs to be longer than the sum of a thickness L₁ of the body 110 and a length L₂ of the lower enclosure 130b. An upper end portion of the bar 140 protrudes from the upper surface of the body 110 in the vertical direction to form a flow channel 120a of the gas simultaneously with serving as a spacer so as to maintain a predetermine interval between the unit cell (not shown) to be disposed on the upper surface of the interconnector 100 and the interconnector 100. In addition, a lower end portion of the bar 140 has a height corresponding to the lowermost portion of the lower enclosure 130b protruding downwardly from the lower surface of the body 110 in the vertical direction, such that the bar may contact the unit cell (not shown) disposed under the lower surface of the interconnector 100 while maintaining a predetermined interval therebetween. Further, since the lower enclosure 130b protrudes from the lower surface of the body 110, such that the lower surface of the interconnector 100 is entirely formed in a concave-convex shape ( [symbol] ). Therefore, this lower enclosure encloses the plurality of bars 140 made of the conductive material, such that the lower enclosure may minimize exposure to the oxidizing atmosphere and hold the bar 140.

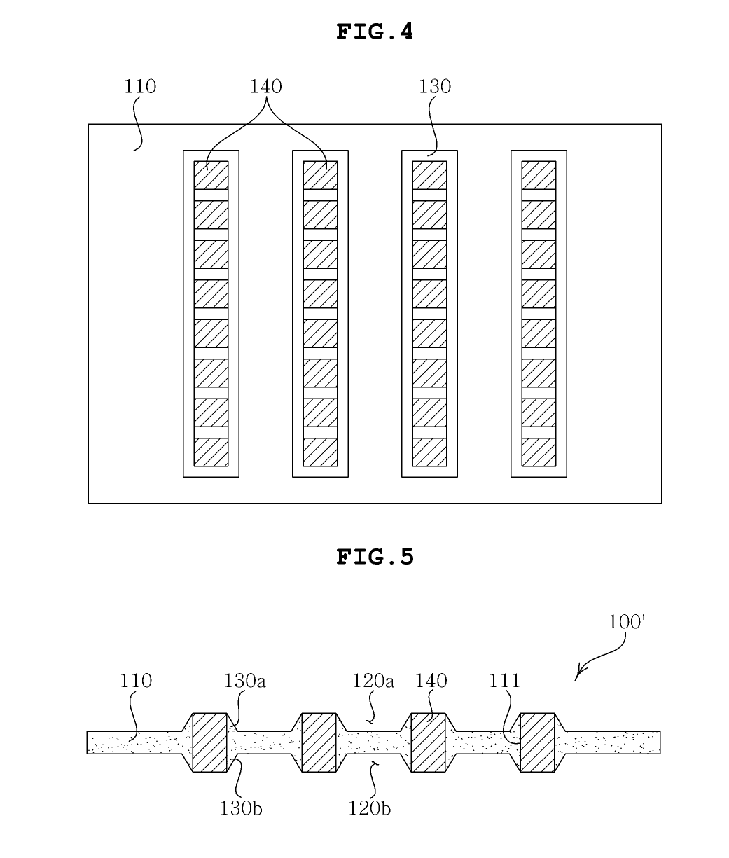

Particularly, the lower enclosure 130b may be formed as an overall rectangular frame (See FIG. 4) so as to simultaneously enclose the plurality of bars 140 arranged in a row. Unlike this, the enclosure may be formed in a cylindrical shape in which the enclosure protrudes downwardly from an edge of each of the through holes 111.

Selectively, in the interconnector 100 according to the present invention, a conductive paste layer 141 is applied between the bar 140 and the cathode 230 of the unit cell (See FIG. 1), such that the interconnector 100 and the cathode of the unit cell may be connected to each other without contact loss. Further, since the conductive paste layer 141 is applied to the lowermost layer of the bar 140, exposure of the bar 140 to the oxidizing atmosphere may be significantly prevented.

In addition, in the interconnector 100 according to the present invention, a conductor 143 such as a nickel foam, or the like, is additionally arranged between the bar 140 and the anode 210 of the unit cell (See FIG. 1), such that the interconnector 100 and the anode of the unit cell may be connected to each other. The conductive paste layer 141 and the conductor 143 as described above may remove gaps between the interconnector 100 and the unit cells to be arranged at upper and lower portions of the interconnector 100, such that direct electrical connection may be internally secured without requiring connection with an external circuit.

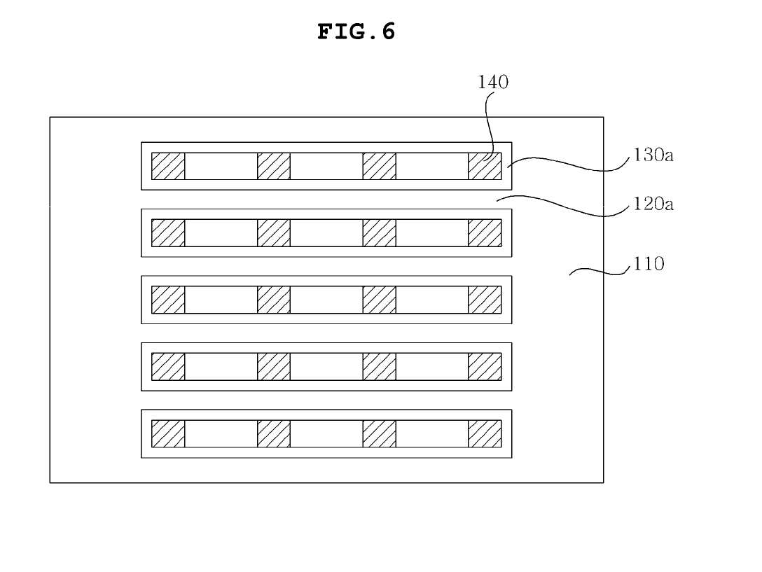

FIGS. 5 and 6 schematically show an interconnector according to another preferred embodiment of the present invention. The interconnector 100′ according to another preferred embodiment of the present invention is similar to the interconnector 100 according to the preferred embodiment of the present invention shown in FIGS. 2 to 4 except for the shape of the upper surface of the interconnector 100. Therefore, in order to assist in the clear understanding of the present invention, a description of components that are similar to or the same as those in the interconnector 100 will be omitted.

In the interconnector 100′ according to another preferred embodiment of the present invention, enclosures 130a and 130b are formed on both surfaces, in other words, upper and lower surfaces, of a body 110. A lower end portion of a bar 140 may be formed to have a height (or level) corresponding to the lowermost portion of the lower enclosure 130b protruding downwardly from the lower surface of the body 110 in a vertical direction so as to contact the unit cell (not shown) to be disposed under the lower surface of the interconnector 100′, and an upper end portion of the bar 140 may be formed to have a height (or level) corresponding to the uppermost portion of the upper enclosure 130a protruding upwardly from the upper surface of the body 110 in the vertical direction so as to contact another unit cell to be disposed on the upper surface of the interconnector 100′. To this end, a length of the bar 140 may be the same as the sum of a thickness L₁ of the body 110(See FIG. 2), a length L₂ of the lower enclosure 130b (See FIG. 2), and a length of the upper enclosure 130a.

For reference, according to the present invention, a conductive paste layer may be applied between the bar 140 and a cathode 230 (See FIG. 1) of the unit cell, and a conductor may be additionally arranged between the bar 140 and an anode 210 of the unit cell (See FIG. 1).

In the interconnector 100′ for a solid oxide fuel cell according to the present invention, each of the channels 120a and 120b are formed on the upper and lower surfaces by means of the enclosure as shown, and the plurality of channels 120a and 120b are formed in parallel with each other so as to be extended from one ends of the upper and lower surfaces to the other ends thereof. The upper surface of the interconnector 100′ has a concave-convex structure through the plurality of channels 120a formed between the upper enclosure 130a having a frame shape so as to receive the bars arranged in a row, and the lower surface thereof has a concave-convex structure through the plurality of channels 120b formed between the lower enclosure 130b having a frame shape. Further, the upper enclosure 130a and the lower enclosure 130b are formed to be perpendicular to each other. For example, the fuel gas (hydrogen) may pass through the channel 120a, and air may pass through the channel 120b, but the fuel gas and the air may not be mixed with each other.

Selectively, each of the enclosures 120a and 120b may have a cylindrical shape in which an edge of each of the through holes 111 protrudes upwardly and downwardly.

As set forth above, according to the present invention, the solid oxide fuel cell mounted with the interconnector capable of physically blocking oxygen (or air) supplied to the cathode from fuel gas supplied to the anode simultaneously with electrically connecting the anode and the cathode of to each other may be provided.

Particularly, according to the present invention, the interconnector exposed to the oxidizing atmosphere is made of the oxidization resistant material, for example, the ceramic material, such that the life span of the planar solid oxide fuel cell may be prolonged.

In addition, according to the present invention, the interconnector and the unit cell may be made of the same material, such that adhesion may be easily implemented, and sealing performance may be improved.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A solid oxide fuel cell comprising:
a unit cell including an anode, an electrolyte, and a cathode;
an interconnector including a planar body, a plurality of through holes penetrating through the body, a bar inserted into the through hole and made of an electrical conductor, and a lower enclosure protruding from one surface of the body so as to enclose the through hole; and
a sealant arranged along edges of the unit cell and the interconnector.

2. The solid oxide fuel cell as set forth in claim 1, wherein the body and the lower enclosure are made of an insulating material, and preferably, an insulating ceramic material.

3. The solid oxide fuel cell as set forth in claim 1, wherein one end of the bar is arranged at the same height as that of the lower enclosure, and the other end of the bar protrudes upwardly from a flat planar surface of the body.

4. The solid oxide fuel cell as set forth in claim 1, wherein the bar has a length longer than the sum of a thickness of the body and a length of the lower enclosure.

5. The solid oxide fuel cell as set forth in claim 1, wherein the lower enclosure has a frame shape so as to enclose the plurality of bars arranged in a row.

6. The solid oxide fuel cell as set forth in claim 1, wherein the lower enclosure has a cylindrical shape so as to enclose an edge of the through hole.

7. The solid oxide fuel cell as set forth in claim 1, further comprising an upper enclosure protruding from the other surface of the body so as to enclose the through hole.

8. The solid oxide fuel cell as set forth in claim 7, wherein the upper enclosure is made of an insulating material, and preferably, an insulating ceramic material.

9. The solid oxide fuel cell as set forth in claim 7, wherein the bar has the same length as the sum of a length of the upper enclosure, a length of the lower enclosure, and a thickness of the body.

10. The solid oxide fuel cell as set forth in claim 7, wherein the upper enclosure has a frame shape so as to enclose the plurality of bars arranged in a row, and the upper and lower enclosures are formed to be perpendicular to each other.

11. The solid oxide fuel cell as set forth in claim 7, wherein the upper enclosure has a cylindrical shape so as to enclose an edge of the through hole.

12. The solid oxide fuel cell as set forth in claim 1, further comprising a conductive paste.

13. The solid oxide fuel cell as set forth in claim 1, further comprising a conductor.
